(19) United States
(12) Patent Application Publication
(10) Pub. No.: US 2019/0135625 A1
(43) Pub. Date: May 9, 2019

(54) STAGED SORBENT ENHANCED METHANE REFORMER

(71) Applicant: GAS TECHNOLOGY INSTITUTE, DES PLAINES, IL (US)

(72) Inventor: Mark FITZSIMMONS, Reseda, CA (US)

(73) Assignee: GAS TECHNOLOGY INSTITUTE, DES PLAINES, IL (US)

(21) Appl. No.: 16/110,672

(22) Filed: Aug. 23, 2018

Related U.S. Application Data
(60) Provisional application No. 62/550,948, filed on Aug. 28, 2017.

(51) Int. Cl. C01B 3/38; B01J 8/06; B01J 8/04; C01B 3/56; B01J 20/34; B01D 53/04

(52) U.S. Cl. CPC C01B 3/38; B01D 2259/40088; B01J 8/0492; B01J 8/0446; C01B 3/56; B01J 20/3483; B01D 53/04; C01B 2203/0233; C01B 2203/043; C01B 2203/0475; C01P 2006/80; B01D 2253/10; B01D 2256/16; B01D 2257/504; B01J 8/065

(57) ABSTRACT

Systems and methods for sorbent enhanced reformation to produce high purity hydrogen. Such systems and methods utilize a reforming unit to process a feed containing methane and steam to produce a reformer product stream containing hydrogen and carbon dioxide, a sorbent unit to absorb at least a portion of the carbon dioxide from the reformer product stream to produce a sorbent unit product stream containing H₂ and used sorbent, a first separation unit to separate H₂ from the used sorbent, a calciner unit to calcine at least a portion of the used sorbent to form a calciner product stream containing regenerated sorbent material and residual gases, a second separation unit to separate the regenerated sorbent material from the residual gases, and a return line to return regenerated sorbent material to the sorbent unit.

### CROSS REFERENCE TO RELATED APPLICATION

This application claims the benefit of U.S. Provisional Patent Application, Ser. No. 62/550,948, filed on 28 Aug. 2017. The co-pending Provisional application is hereby incorporated by reference herein in its entirety and is made a part hereof, including but not limited to those portions which specifically appear hereinafter.

### BACKGROUND OF THE INVENTION

### Field of the Invention

This invention relates generally to the production of hydrogen from methane and, more particularly, to improved methods, devices and systems of or for Sorbent Enhanced Reformation (SER) for producing hydrogen from methane.

### Description of Related Art

Steam Methane Reforming (SMR) is a typical commercially practiced process in refineries for producing hydrogen from methane. In SMR, methane and steam are typically passed over a catalyst which causes the steam and methane to reform according to the reforming reaction:

CH₄+2H₂O→CO₂+4H₂ (1)

While some SMR systems use packed sorbent beds for absorbing CO₂, these beds are commonly cycled at high temperatures which leads to rapid degradation of the sorbent through sintering.

With the above reforming reaction, half of the produced hydrogen comes from methane, and half of it comes from water. In practice, however, this reaction does not go to completion. The quantity of methane that does not react is called “methane slip.” Methane slip is attributable at least in part to resistance to producing CO₂ due to high CO₂ partial pressure, which also causes CO to form. Methane slip can be reduced by increasing steam flow rate, however there is a cost penalty to boiling extra water. Typically, economical processes find that hydrogen production reaches a minimum cost per unit mass with a steam/carbon ratio between 2.5 and 3, depending on the cost of energy to boil water. Since the 1950's, the following calcium carbonation reaction between CO₂ and CaO (calcium oxide) has been known to reduce methane slip in the aforementioned reforming reaction:

CaO+CO₂→CaCO₃ (2)

This reaction can serve to reduce the CO₂ partial pressure, thus reducing the quantity of CO, CO₂ and CH₄ in the hydrogen product gas by increasing the reforming reaction and increasing the water gas shift reaction:

CO+H₂O→CO₂+H₂ (3)

This combination of reforming, calcium carbonation and water gas shift is typically referred to or called Sorbent Enhanced Reformation (SER).

While there are various benefits associated with the calcium carbonation reaction, there are also some problems and as a result the development of an economical process can in practice be difficult. For example,

1. Carbonation of calcium oxide is a highly exothermic reaction. This can be beneficial because methane reformation is highly endothermic. Process designs which are “economical” may recuperate this heat and transfer it to the reforming reaction. This typically requires that the two reactions take place in close physical proximity for best efficiency.

2. The calcium (e.g., pulverized limestone) which is used to absorb the CO₂ must be recycled, typically by processing involving heating to release the CO₂, which is either captured for sequestration or vented. Such repeated heating/cooling processing has been demonstrated to “sinter” the molecules, which decreases the porosity of the solid structure and therefore reduces the available surface area of CaO for carbon dioxide capture. Experiments have demonstrated that the calcium oxide can lose efficacy over time, typically in 20-200 cycles. An economical process desirably minimizes sintering.

3. Other contaminants in the limestone (e.g., alumina and silica in particular) can produce cementitious molecules which react readily with water, producing concrete-like materials. These materials have been demonstrated to coat metal surfaces and catalyst particles in sorbent enhanced reformation processes. An economical process desirably must minimize this type of fouling.

4. During calcination when this reaction is reversed, loose metals in the sorbent may become oxygen carriers, which then burn up or consume some of the product gas (hydrogen) when the sorbent is re-introduced to the reformer. A fluidized bed reformer where sorbent and catalyst are fluidized can cause significant amounts of nickel to be released (by attrition) to circulate with the sorbent. The product thus burned up or consumed simply becomes steam again, negating the positive effects of SER. Desirably, such attrition is minimized, avoided or otherwise prevented.

One step or single step SER has been shown to have a high risk of deactivation of relatively fresh catalyst (a high cost consumable, for which long life is required). Furthermore, fluidized bed catalyst in such tests have been shown to experience a high rate of degradation from attrition. The catalyst can lose several percent by mass in only hours or days of operation. Moreover, recirculating catalyst containing nickel commonly leads to introduction of nickel (known to be an efficient oxygen carrier) into the recycled sorbent. This recirculation leads to oxygen transport into the feed gas (primarily hydrogen and CO) on the surface of sub-micron catalyst particles, where the oxygen reacts with the product, consuming CO and hydrogen. In a short period of time, this metal oxide can build to levels where a large fraction of the product is burned in the product gas stream.

There is a need and a desire for methods, devices and/or systems of or for Sorbent Enhanced Reformation (SER) for producing hydrogen from methane by which the one, two, three, or preferably all four of above-identified four requirements or items can be properly satisfied with little or, preferably, no negative consequences.

### SUMMARY OF THE INVENTION

This invention provides methods, devices and/or systems of or for Sorbent Enhanced Reformation (SER) for producing hydrogen from methane by which the one, two, three, or preferably all four of above-identified four requirements or items can be properly satisfied with little or, preferably, no negative consequences.

In accordance with one aspect, there is disclosed a staged SER system which alternates between SMR and absorption of CO₂ in order to maintain separation between sorbent and catalyst, such as to prevent catalyst blocking by cementitious particles.

In accordance with one aspect of the subject development, a packed bed catalyst is maintained to prevent attrition, and a fluidized bed absorber is maintained for good thermal integration.

In accordance with one aspect of the subject development, a system for producing hydrogen from methane is provided and which system includes a plurality of stages, each stage comprising a fixed bed catalyst packed into tubes arranged in a process vessel, with the process vessel containing sorbent capture material forming a fluidized bed in heat exchange communication with the fixed bed catalyst packed in the tubes.

A system of producing hydrogen in accordance with one embodiment includes a reforming unit containing a bed of methane reforming catalyst to process a feed containing methane and steam to produce a reformer product stream containing hydrogen and carbon dioxide. The system also includes a sorbent unit containing a bed of carbon dioxide sorbent material. The sorbent unit is operatively connected to the reforming unit to process the reformer product stream with the sorbent material absorbing at least a portion of the carbon dioxide from the reformer product stream to produce a sorbent unit product stream containing H₂ and used sorbent. A first separation unit is operatively connected to the sorbent unit to process the sorbent unit product stream to separate H₂ from the used sorbent. A calciner unit is operatively connected to the first separation unit to calcine at least a portion of the used sorbent to form a calciner product stream containing regenerated sorbent material and residual gases. A second separation unit is operatively connected to the calciner unit to process the calciner product stream to separate the regenerated sorbent material from the residual gases. A return line is operatively connected to the second separation unit to return regenerated sorbent material to the sorbent unit.

In accordance with another aspect of the subject development, there is provided a method for producing hydrogen from methane.

In one embodiment, such a method involves staged sorbent enhanced methane reformation.

In one embodiment, such a method involves alternating between SMR and absorption of CO₂ in order to maintain separation between sorbent and catalyst.

In accordance with one embodiment, a method for sorbent enhanced reformation of methane to form hydrogen is provided wherein feed materials including methane and steam are introduced into a reforming unit containing a bed of methane reforming catalyst to produce a reformer product stream containing hydrogen and carbon dioxide. The reformer product stream is introduced into a sorbent unit containing a bed of carbon dioxide sorbent material to produce a sorbent unit product stream containing H₂ and used sorbent. The sorbent unit product stream is introduced into a first separation unit to separate H₂ from the used sorbent. The used sorbent is introduced into a calciner unit to calcine at least a portion of the used sorbent to form a calciner product stream containing regenerated sorbent material and residual gases. The calciner product stream is introduced into a second separation unit to separate the regenerated sorbent material from the residual gases. At least a portion of the regenerated sorbent material are subsequently introduced to the sorbent unit.

In specific embodiments, systems and methods in accordance with the invention includes one or more stages to produce high purity hydrogen.

In specific embodiments, systems and methods in accordance with the invention produce high purity hydrogen is at either of both lower temperatures and higher purity than that produced via steam-methane reformers.

Those skilled in the art and guided by the teachings herein provided will understand and appreciate that SMR has a theoretical limit of 80% purity hydrogen with uneconomical levels of steam production, but in an economic process produces hydrogen of approximately 71-76% purity prior to carbon dioxide capture but after condensing of liquid water at a temperature of 750° C. (the optimal temperature for such processing). After a post-reforming carbon capture process, the hydrogen purity of this processing could be enhanced to about 81-83% purity. In contrast, processing via SER and in accordance with the subject invention development at the same steam to methane ratio would produce hydrogen of purity of about 84-96% after condensing liquid water at only about 660° C. optimal temperature due to integral carbon capture and enhancement of the reforming reaction.

In specific embodiments, systems and methods in accordance with the invention produce hydrogen using sorbent enhanced reforming (SER) which maintains separation of sorbent and catalyst.

In specific embodiments, systems and methods in accordance with the invention are continuous systems and methods of sorbent enhanced reformation which do not require thermal cycling of a static sorbent bed.

In specific embodiments, systems and methods in accordance with the invention utilize a fluidized bed CO₂ absorbing unit (absorber stage) which is thermally connected to a static reforming bed (reformer stage).

In specific embodiments, systems and methods in accordance with the invention utilize a fluidized bed CO₂ absorbing unit which is designed to be fluidized by one or more of the feed and product gases (e.g., one or more of hydrogen, carbon monoxide and carbon dioxide).

In specific embodiments, systems and methods in accordance with the invention utilize fluidized bed stages which are sized such that the product feed from the prior stage will fluidize the sorbent bed.

In specific embodiments, systems and methods in accordance with the invention utilize a pressurized feed stream which is compressed above atmospheric pressure sufficiently to allow fluidization of approximately 2-4 meters of fluidized bed, with the uppermost and final stage exiting at approximately atmospheric pressure, or somewhat below atmospheric pressure.

In specific embodiments, systems and methods in accordance with the invention utilize a stage design which may be stacked vertically to minimize compression power to lift solid sorbent, and such that the sorbent may be fed in a column to the lower beds by means of standpipe pressurization (the natural pressurization of a downward-flowing standpipe).

In specific embodiments, systems and methods in accordance with the invention utilize a sorbent material which is properly sized so that the sorbent terminal velocity is less than the fluidized bed superficial velocity, such that substantially all of the sorbent material will be transported from each stage to a separation device such as a filter or cyclone.

In specific embodiments, systems and methods in accordance with the invention utilize a system of stages which integrates the flows of reformers and absorbers in such a way as to allow continuous looping of solid sorbent with a once-through path of methane, steam, hydrogen, carbon monoxide and carbon dioxide, and a separate once-through path of methane and oxygen or methane and air through a calciner.

In specific embodiments, systems and methods in accordance with the invention utilize a feed system gas pressurization or educator which is fed by a compressed stream of product from one of the stages, and which carries calcined sorbent back up to the first stage.

In specific embodiments, systems and methods in accordance with the invention utilize a flash calciner which minimizes residence time of sorbent while raising it to a temperature which allows for some heat loss to a first stage of absorption, but retains enough heat to avoid resorption of CO₂ product in a separation device such as a filter.

In specific embodiments, systems and methods in accordance with the invention utilize a system of fluidized bed stages wherein temperature is controlled by one or more and preferably by each of the following factors: the temperature of the feed steam and methane, electrical heat trace and insulation on the vessels, and the thermal input of the calciner.

In specific embodiments, systems and methods in accordance with the invention can be tuned to produce a mixed product of H₂ and CO (syngas) at a variety of molar ratios required for downstream chemical processes by using more or fewer stages and adjusting operating temperatures.

In specific embodiments, systems and methods in accordance with the invention utilize staged sorbent enhanced methane reformation.

In specific embodiments, systems and methods in accordance with the invention alternate between SMR and absorption of CO₂ in order to maintain separation between sorbent and catalyst.

In specific embodiments, alternating between SMR and absorption of CO₂ is effective to prevent catalyst blocking by cementitious particles.

In specific embodiments, systems and methods in accordance with the invention utilize a plurality of stages, each stage comprising a fixed bed catalyst packed into tubes arranged in a process vessel, with the process vessel containing sorbent capture material forming a fluidized bed in heat exchange communication with the fixed bed catalyst packed in the tubes.

### BRIEF DESCRIPTION OF THE DRAWINGS

Objects and features of this invention will be better understood from the following description taken in conjunction with the drawings, wherein:

FIG. 1 is a graphical presentation of CO₂ in the output stream versus hydrogen product for SMR in accordance with one aspect of the development and at selected pressures, over a range of temperatures from 475° C. to 875° C.

FIG. 2 is a graphical presentation of SER/SMR ratio across a range of temperatures and pressures.

FIG. 3 is a graphical presentation of SER/SMR ratio improvement in productivity and peak H₂ moles/moles of CH₄, respectively, versus pressure, showing pressure effect on output.

FIG. 4 is a graphical presentation of Ca(OH)₂ fraction and H₂O partial pressure, respectively, versus pressure, showing the pressure effect on output.

FIG. 5 is a graphical presentation of temperature versus pressure showing the effects of temperature and pressure on SMR, calcination and SER, respectively.

FIG. 6 is a simplified flow schematic of one stage in accordance with one aspect of the subject development.

FIG. 7 is a graphical presentation of H₂/CH₄ ratio and CO₂ capture as a function of the number of stages.

FIG. 8 is a graphical presentation of H₂, CO₂ and CO, respectively, as a function of the number of stages.

FIG. 9 is a schematic representation of a physical arrangement of a basic unit (one stage) in accordance with one aspect of the subject development.

FIG. 10 is a schematic representation of a physical arrangement of a basic system composed of five stages in accordance with one aspect of the subject development.

### DETAILED DESCRIPTION

One aspect of the present development is directed to a method of performing sorbent enhanced reformation which at least minimizes and preferably avoids or prevents the above-identified problems. US 2010/0092379 A1, the disclosure of which is incorporated herein in its entirety, describes a device which performs calcination without adversely affecting the sorbent particle surface area and porosity. The incorporation and use of such a device or the like can be important to the practice of the present development.

As detailed below, the subject development desirably provides ways, methods and/or techniques by which one, two, three or preferably all four of the above requirements can be and are satisfied with little or preferably, no negative consequences.

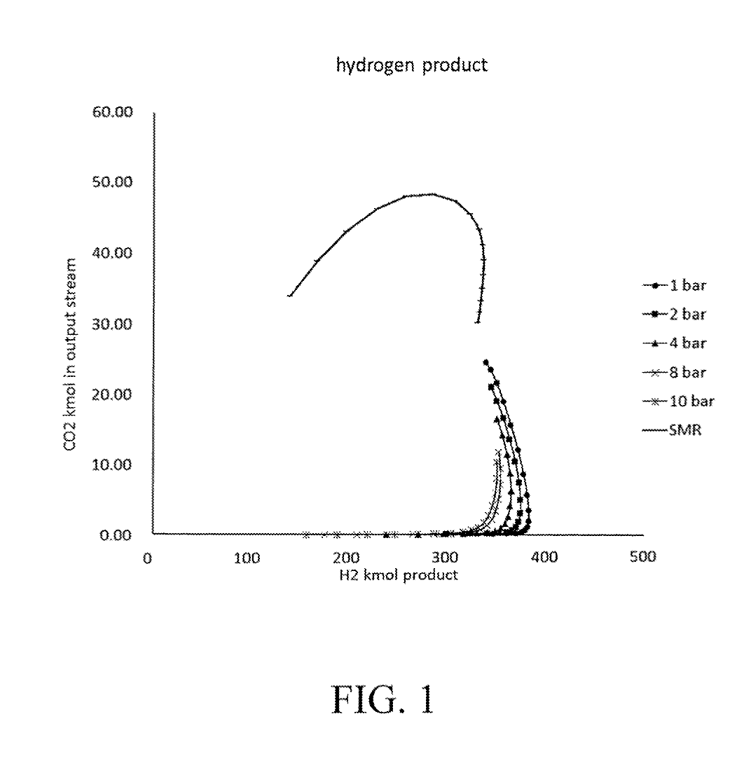

Firstly, in order to assess the appropriate pressure of a process, the equilibrium reactions are shown in FIG. 1. FIG. 1 shows the maximum hydrogen produced per 100 kmol of CH₄, showing CO₂ waste gas in the output streams. Each curve traverses a range of temperatures from 475° C. to 875° C. For 100 kmol of CH₄, the theoretical maximum hydrogen possible is 400 kmol. In practice, using the traditional SMR process, the highest molar ratio of product (H₂) to feed (CH₄) is 3.38, or 338 kmol/100 kmol methane at a steam to carbon (S/C) ratio of 3.0 at atmospheric pressure (shown in the figure in green), and this maximum occurs at a temperature of approximately 730° C. In contrast, SER can produce 3.85 moles of H₂ per mole of CH₄, or 384 kmol/100 kmol methane (assuming the calcium sorbent is intimately commingled with the catalyst), and this takes place at only 630° C. At higher pressures, the amount of hydrogen produced is lower than these maxima. It is important to note that the point of these maxima are not at the same temperature, as this leads to an economic advantage in heating and thermal losses. For SER, the reaction takes place at temperatures at least 100° C. lower than the peak for SMR, making SER more cost effective from a waste heat standpoint.

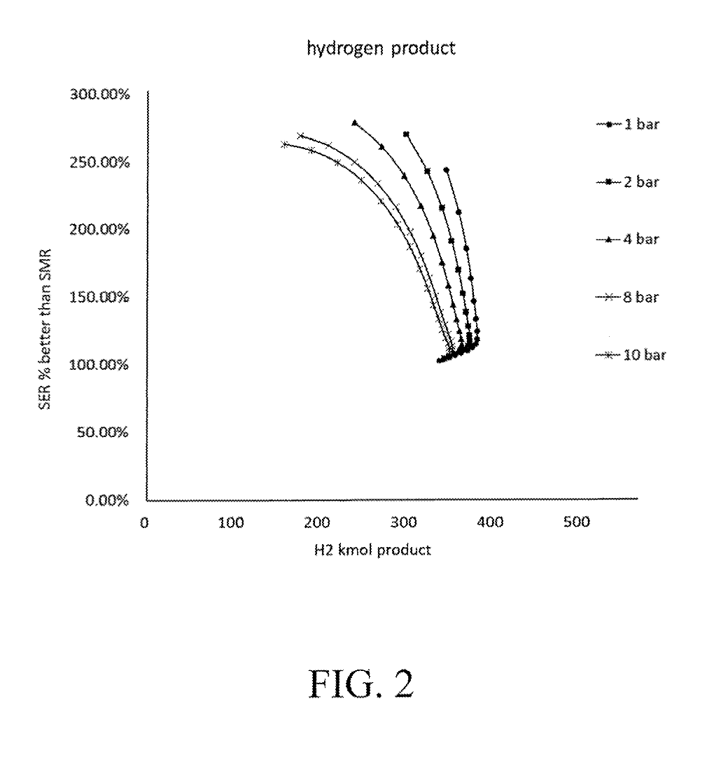

FIG. 2 shows the hydrogen product ratio of SER/SMR when the processes are carried out at the same temperatures.

For FIGS. 1 and 2:

1. the 1 Bar SMR peak was in a range of 720-790° C.;

2. the 1 Bar SER peak was in a range of 610-700° C.;

3. the 2 Bar SER peak was in a range of 660-740° C.; and

4. the 4 Bar SER peak was in a range of 715-790° C.

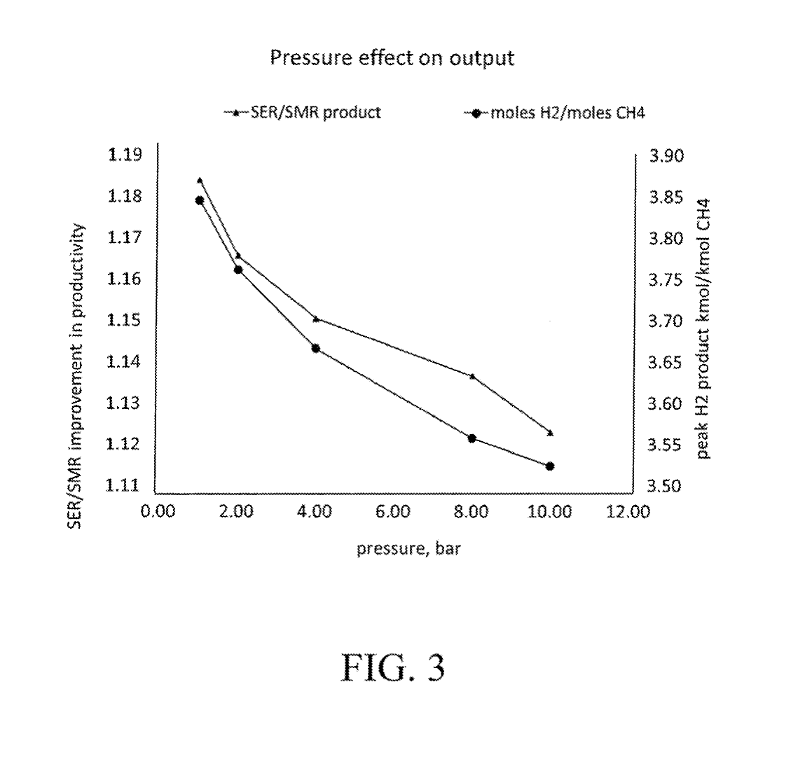

The peak hydrogen product maxima from FIG. 2 are plotted in FIG. 3, which illustrates that the maximum benefit for SER is seen at atmospheric pressure, and produces 18.4% more hydrogen than SMR.

In addition to producing more hydrogen, a benefit, SER also has the negative result of producing calcium hydroxide, such as can react with alumina, silica, and other metal oxides to produce cement. In fluidized bed SER tests, this has been shown to cause irreversible damage to catalyst by coating and blocking gas movement from the fluid bed emulsion to the surface of the catalyst where the reformation reactions take place. The highly kinetic environment with active ions and protons at elevated temperature has the effect of accelerating curing reactions of the cementitious products. Combined with the highly exothermic reactions of carbon dioxide absorption, high particle surface temperatures can take place which force further irreversible reactions, curing cementitious deposits onto the surface of the catalyst, which cannot then be removed. Thus, although calcium hydroxide will react with carbon dioxide to capture CO₂, its presence among catalyst also can be detrimental, and it preferably should be avoided.

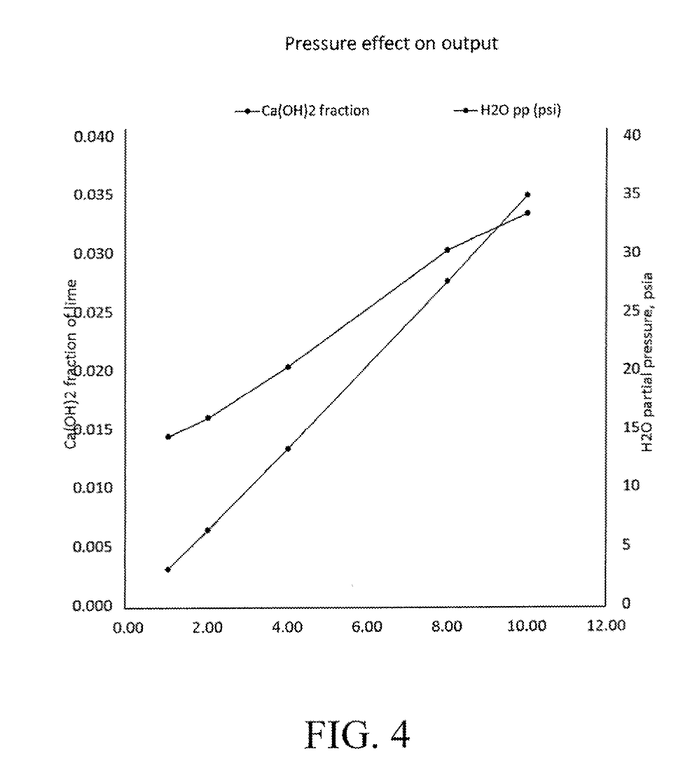

FIG. 4 shows that the presence of Ca(OH)₂ is increased at high pressure.

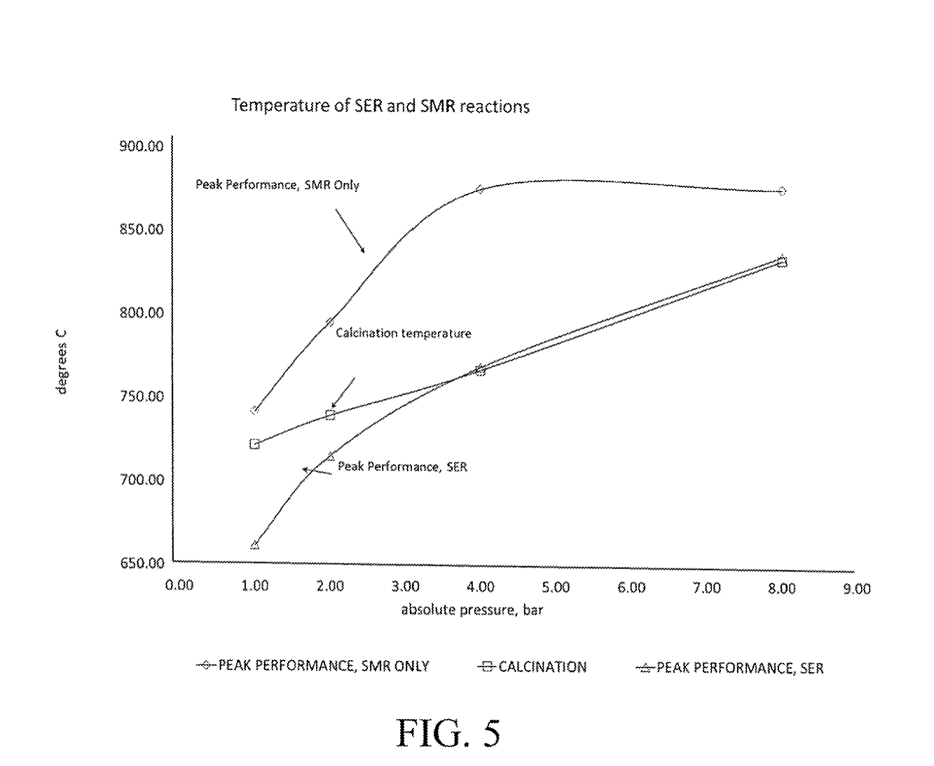

Furthermore, higher pressures also may produce two more negative effects, which are depicted in FIG. 5. First, the temperature at which calcination takes place increases, which necessiates more heat to be pumped into the system to force the carbon release reaction to take place. Secondly, at about 3.5 bar, the calcination temperature is no longer higher than the peak temperature for hydrogen production. In a SER process, the carbon capture must be performed at a temperature that is below the calcination temperature. If the calcination temperature is lower than the optimum temperature for hydrogen production, a lower, and therefore less optimal temperature must be used for the carbon capture step, or a pressure swing must be added to the process. Finally, a benefit is also seen for production at low pressure, which is that the optimal SER temperature is considerably lower than the optimal temperature for SMR processes. This means that the equipment can operate at temperatures which are more forgiving for materials, there is less heat loss, and the cost of producing steam to feed the process is lower.

The graphs shown in FIGS. 1-5 indicate the design requirements and operating envelope for a novel process, in which the gases (methane and steam) are passed through a series of stages, first reforming, then capturing CO₂ in a solid sorbent, separating the sorbent from the stream, and repeating this.

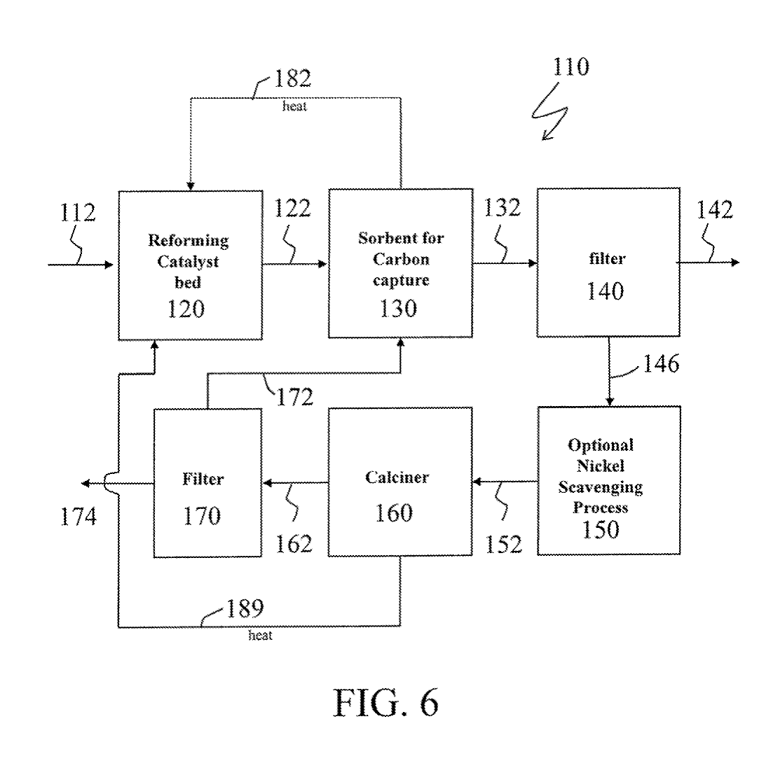

The basic chemical process is shown in FIG. 6 relative to a process system, generally designated by the reference numeral 110, and which schematically illustrates one stage of a process in accord with the subject development.

In the process system 110, an input stream 112 such as including methane and steam forms material inputs into a reforming catalyst bed unit 120.

A stream 122 such as including hydrogen, methane, stream, carbon dioxide (CO₂), and carbon monoxide (CO) forms material outputs from the reforming catalyst bed unit 120 and forms material inputs to a sorbent unit 130 for the capture of carbon.

A stream 132 such as including hydrogen, methane, stream, carbon dioxide (CO₂), carbon monoxide (CO) and calcium carbonate such as formed in or by the sorbent unit 130 forms material outputs from the sorbent unit 130 and forms material inputs to a filter or other selected separation unit 140.

The filtration unit 140 produces or forms a filtrate stream 142 such as including hydrogen, methane, stream, carbon dioxide (CO₂), and carbon monoxide (CO). As described below, the filtrate stream 142 can desirably be passed to a subsequent stage for further processing in accordance with the invention. The filtration unit 140 also forms a residue stream 146 such as containing calcium carbonate.

If desired, the residue stream 146 can be passed to an optional nickel scavenging process unit 150, such as known in the art, to recover nickel that may be present in the residue stream 146.

A stream 152 such as including calcium carbonate is introduced into a calciner unit 160 to undergo calcination. The calcium carbonate may be passed to the calciner unit 160 directly from the filtration unit 140 or via the nickel scavenging process unit 150, if present. Within the calciner unit 160, calcium carbonate is calcined to form or result in calcium oxide.

In practice, the sorbent will likely evolve over time. Thus, if desired or required, fresh sorbent material precursor such as nearly 100% CaCO₃, for example, can be introduced into the process system, such as at stream 152. Such added sorbent material, for example, over the course of several calcination steps, eventually would calcine, evolve or form a suitable absorbent material such as 50-80% CaO.

A stream 162 such as including calcium oxide and carbon dioxide (CO₂) results from the calciner unit 160 and forms material inputs to a post-calciner filter or other selected separation unit 170. As shown, the post-calciner filter or filtration unit 170 can desirably serve to form a residue stream 172 of calcium oxide such as can be introduced into the sorbent unit 130 for use in the capture of carbon from the stream 122 from the reforming catalyst bed unit 120. A stream 174 such as of carbon dioxide (CO₂) separated from calcium oxide via the post-calciner separation unit 170 can be appropriately vented or sequestered, as is known in the art.

The processing system 110 can advantageously recycle or recoup heat, such as from either or both the sorbent unit 130 and/or the calciner unit 160 and such as to the reforming catalyst bed unit 120, such as schematically by the lines 182 and 184, shown in FIG. 6.

As will be appreciated, the FIG. 6 depiction of the process system 110 has been simplified such as by not showing commonly known input streams, such as of oxidant, e.g., air, and fuel, e.g., natural gas, to the calciner unit 160, for example. Further it will be appreciated by those skilled in the art and guided by the teachings herein provided that streams such as the residue stream 172 introduced into the sorbent unit 130 and the stream 152 passed to the calciner unit 160 will typically not be 100% calcium oxide or calcium carbonate, respectively, but rather will contain or include a predominance of one species over the other, for example, there might be a particle that is 70% CaO and 30% CaCO₃ which transitions to 90% CaCO₃ and 10% CaO.

In contrast to a single stage process in which the calcium oxide and calcium carbonate are contained within a fixed bed and the gas is passed through this material in a batch mode, a multi-stage continuous process such as is the subject of the present invention differs has not previously been disclosed

By repeating these steps, the staged process can produce the same quantity of hydrogen as a one-step intimate blending process described above in approximately 7-9 stages.

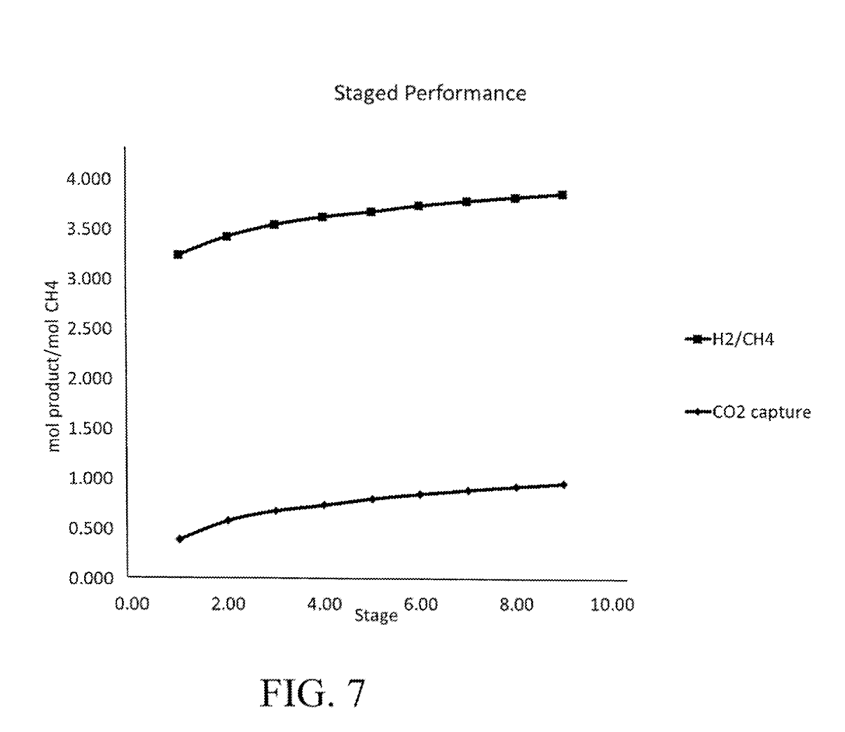

This is depicted in FIG. 7.

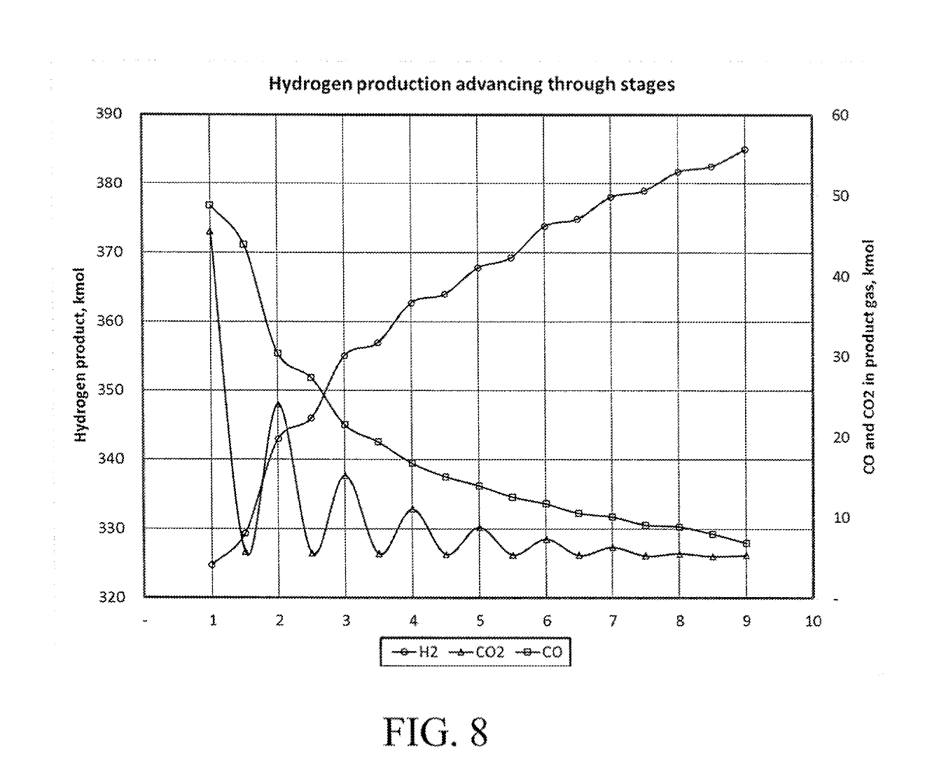

FIG. 8 graphically illustrates the molar composition of product as a function of stages.

The method by which these stages are arranged can be critical to the function of the system. Each stage can desirably include a reforming catalyst bed 120 composed of a fixed bed catalyst, packed into tubes. The arrangement of tubes within a separate vessel may be in the form a heat exchanger (known to one practiced in the arts as a shell-and-tube or tube sheet heat exchanger). As methane-containing gas passes through the catalyst, an endothermic reaction takes place, reducing the temperature. These catalyst tubes can desirably be welded into a fluidized bed, which forms the sorbent capture portion of that stage. The sorbent capture is exothermic, and these two reactions although separated by the tube sheet, can exchange heat. The net reaction is slightly endothermic, but this can be compensated for by further embedding a burner/calciner in which the calcium carbonate gives up or releases its CO₂. Upon exiting the catalyst tube, the gases, which now contain less methane and more hydrogen, are passed into the sorbent capture box, a fluidized bed, in which an exothermic reaction takes place. The fluidized bed accomplishes at least two things: it ensures good mixing and contact between the gas and the sorbent, and it also ensures that there is high heat transfer between the exothermic sorbent and the endothermic catalyst. Furthermore, the described tube arrangement can allow slight pressure differences to exist between the processes exchanging heat, such that calcination can take place at somewhat lower temperatures.

Again referencing FIG. 6, the gas and sorbent (stream 132) pass out of the fluidized bed sorbent unit 130 and into a cyclone or filter 140, where the gases and solids are separated into streams 142 and 146. Stream 142 passes to the next stage, and stream 146 moves through a calciner 160 for re-use. The calciner 160 may be a flash type calciner with short residence time, such as known in the art, which lengthens the life of the sorbent. This separates the sorbent into two streams: a solid stream of CaO+CaCO₃ (stream 172), and a gas stream of CO₂ and H₂O (stream 174). In a full scale system, it is unlikely that a calciner will be required at every step. The first stage which performs the most reforming is the stage which is the most endothermic, and would likely require the most extra heat, and is the logical stage for the placement and inclusion of a calciner. The sorbent exiting the first stage as stream 172 would therefore also have the most CaO, and would be best suited to capture the most CO₂ in the final “polishing” stage. Thereafter, the sorbent may be passed backward from upper stages to lower stages without calcining. In these upper stages, therefore, stream 146 could pass directly to the previous stage (such as by gravity, by arranging stages from bottom to top, for example). The calciner unit 160 may exchange heat with the reformer 120 or the fluidized bed absorber 130, or both, or neither. The choice depends on the process temperature chosen, and the scale of the system, the primary guiding factor being the requirement that the filter must remain above the calcination temperature of the sorbent to avoid resorbing CO₂.

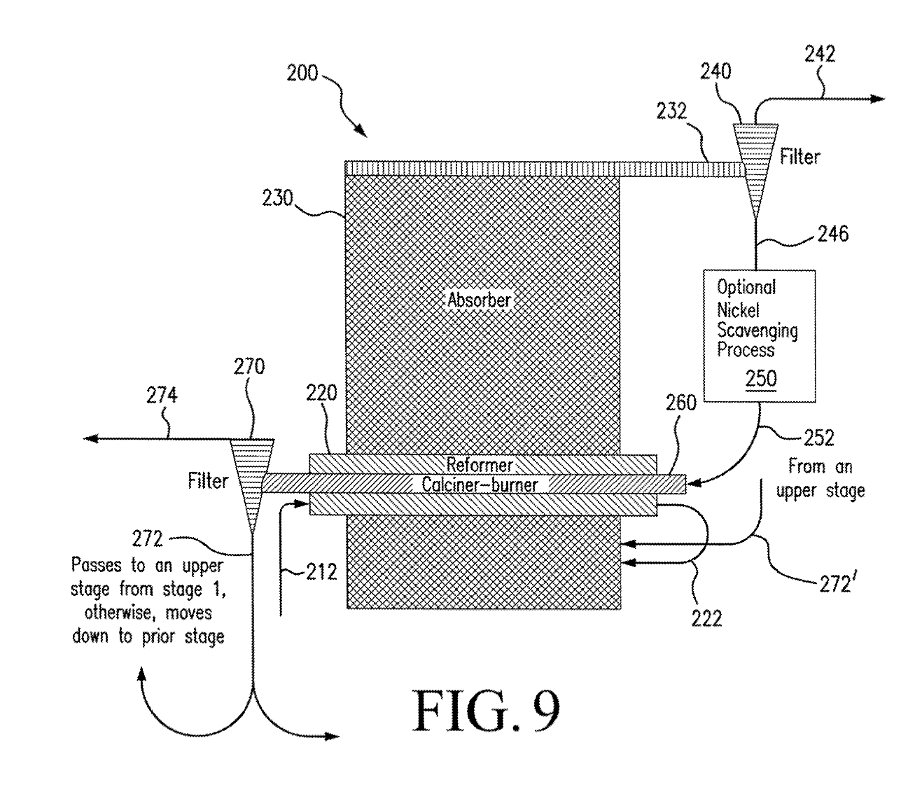

FIG. 9 schematically illustrates a physical arrangement of a basic unit (one stage) designated 200, in accordance with one embodiment of the subject development. In the system 200, the stream 212 is a feed stream such as includes steam and methane. The stream 212 is introduced into the reformer 220 to form a stream 222 of intermediate product, e.g., before carbon dioxide capture. The stream of intermediate product is passed to the sorbent bed 230 and processed therein to produce a stream 232 of mixed product and sorbent. The stream 232 is passed to a filter or other selected separation unit 240 forming a product stream 242 and a stream 246 containing used sorbent. As shown, the stream 246 can be passed to an optional nickel scavenging process unit 250, such as known in the art, to recover nickel that may be present in the stream 246. A stream 252 such as including calcium carbonate is introduced into a calciner unit 260 to undergo calcination. The calciner-burner 260 is not necessarily a fluidized bed (although it could be). Material treated in the calciner unit 260 is passed to a post-calciner filter or other selected separation unit 270 forming a stream 272 of regenerated sorbent, e.g., calcium oxide, and a stream 274 such as composed of CO₂ and steam, The stream 272 of regenerated sorbent can be used for further processing such as by being passed to an upper stage from stage 1, but otherwise passed down to prior stage, such as represented by the stream 272′.

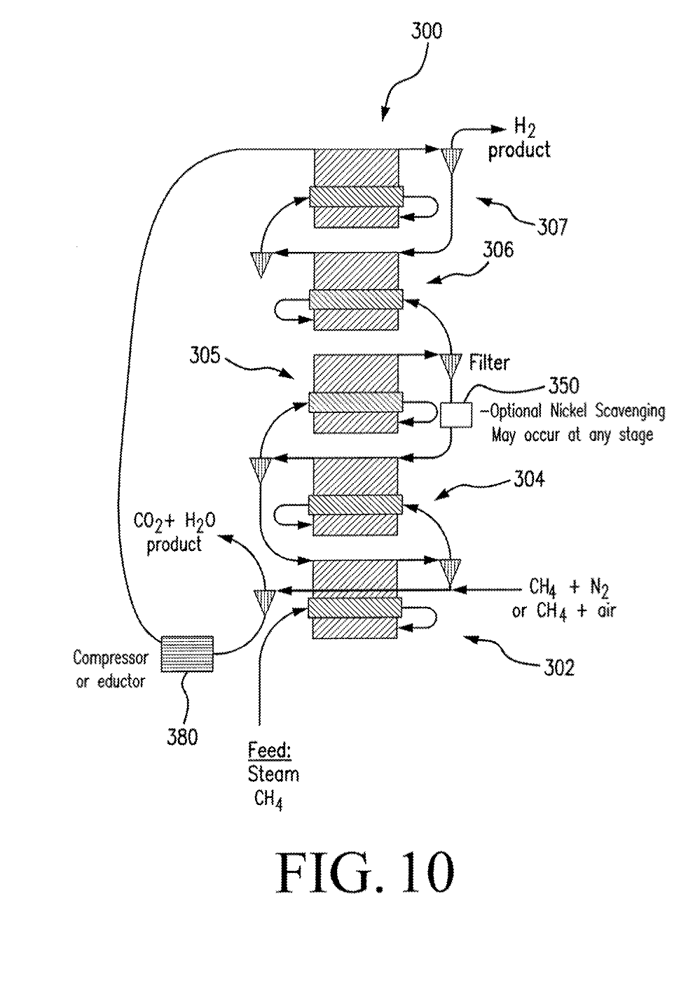

FIG. 10 schematically illustrates a physical arrangement of a system 300 made up of five stages in accordance with one embodiment of the subject development.

The system 300 includes a first stage 302 as well as four additional subsequent stages 304, 305, 306, and 307, respectively. The first stage 302 is generally similar to the stage 200 shown in FIG. 9 and described above except the stage 302 does not show inclusion of an optional nickel scavenging unit. However, as will be appreciated by those skilled in the art and guided by the teachings herein provided, if desired, such a nickel scavenging unit can be appropriately included or occur as any desired stage. Thus, FIG. 10 shows the inclusion of an optional nickel scavenging unit 350 for processing material passing from stage 305 to stage 304, for example.

While the five stage system 300 shown in FIG. 10 is depicted as having or including a calcination step associated with each stage, those skilled in the art and guided by the teaching herein provided will understand and appreciate that a suitable system can be constructed or designed such that one calciner can be used to sufficiently regenerate sorbent from two or more stages.

A compressor or eductor 380 may be fed pneumatically from any of the product streams after being compressed, or the solids may be lifted by a mechanical elevator or particulate solid pump for delivery to the sorbent bed of the uppermost stage 307, e.g., the stage at the highest elevation above the ground, i.e., the last stage.

Making reference to the stream number identified in connection with the stage 200 shown in FIG. 9, as will be appreciate in the operation of such a multistage system, the stream 242 of a stage A becomes the stream 212 of stage A+1, and so forth. Further, the stream 246 of used sorbent or, if an optional nickel scavenging unit is present, the stream 252 from stage A would move or be passed to the stage A−1. The stream 272 of regenerated sorbent from first stage, e.g., the stage 302, is passed, such as via the compressor or eductor 380 to the upper most stage, e.g., stage 307.

The subject development advantageously can provide high purity hydrogen with capture of CO₂.

Benefits or advantages that can be realized or achieved through application and practice of the subject development may desirably include one or more of the following:

1. The compression energy required to lift the sorbent, plus the energy to calcine the captured CO₂, can be subtracted from the savings in enthalpy by heating the feed to 650° C. instead of 750° C. is a reasonable measure of comparative effectiveness between this development and the common industrial practice of SMR.

2. The thermal savings can be significant (e.g., about 363 joules/kg of feed (steam+methane to 650° C. instead of 750° C.)), while the additional compression energy required to lift the sorbent is about 50 joules/kg of recycled gas used to convey the sorbent, however, the mass of gas required is only about 1/10 of the mass of feed, so in terms of j/kg of FEED, the energy is ˜5 joules/kg of feed. The additional energy required to heat the sorbent up to calcination temp is about 21 joules/kg (of FEED), which leaves a net savings of 339 joules/kg feed compared to SMR. If these savings are multiplied by 118% (because the process yields 18% more H₂), the savings are even greater, in terms of hydrogen produced. In terms of the total energy which would be required to heat the feedstock for normal SMR process, this is about 14% of the energy saved to produce hydrogen. The pressure required to move the feed through the stages of fluid beds, catalyst beds, and filters is approximately 0.6-1.0 psi per stage, or a total pressure drop of 6-9 psid, thus the first stage would operate at some pressure near or below 2 atmospheres absolute, and the last stage at atmospheric pressure.

It is to be understood that while systems in accordance with at least some of the aspects of the subject development maybe somewhat more complicated mechanically, due to circulating solid stream of sorbent, such systems are generally similar in complexity to fluidized bed catalytic crackers which are in widespread use.

While in the foregoing detailed description the subject development has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the development.

What is claimed includes:

1. A system of producing hydrogen, the system comprising:
a reforming unit containing a bed of methane reforming catalyst to process a feed containing methane and steam to produce a reformer product stream containing hydrogen and carbon dioxide;
a sorbent unit containing a bed of carbon dioxide sorbent material, the sorbent unit operatively connected to the reforming unit to process the reformer product stream with the sorbent material absorbing at least a portion of the carbon dioxide from the reformer product stream to produce a sorbent unit product stream containing H₂ and used sorbent;
a first separation unit operatively connected to the sorbent unit to process the sorbent unit product stream to separate H₂ from the used sorbent;
a calciner unit operatively connected to the first separation unit to calcine at least a portion of the used sorbent to form a calciner product stream containing regenerated sorbent material and residual gases;
a second separation unit operatively connected to the calciner unit to process the calciner product stream to separate the regenerated sorbent material from the residual gases; and
a return line operatively connected to the second separation unit to return regenerated sorbent material to the sorbent unit.

2. The system of claim 1 which maintains separation of sorbent and catalyst.

3. The system of claim 1 wherein the sorbent unit is thermally connected to a static reforming bed.

4. The system of claim 1 wherein the sorbent unit is fluidized by one or more of the feed and product gases.

5. The system of claim 1 comprising a plurality of in-series stages, each stage including at least one of said reforming units paired with at least one of said absorbent units.

6. The system of claim 5 wherein the sorbent material is sized so that the terminal velocity of the sorbent material is less than the fluidized bed superficial velocity such that substantially all of the sorbent material will be transported from each stage to the respective first separation unit.

7. The system of claim 5 wherein the plurality of in-series stage are vertically stacked.

8. The system of claim 7 additionally comprising an educator fed by a compressed stream of product from one of the stages and which carries calcined sorbent to the last stage.

9. The system of claim 5 wherein each stage comprises a fixed bed catalyst packed into tubes arranged in a process vessel.

10. The system of claim 9 wherein the process vessel contains the sorbent material and the sorbent material forms a fluidized bed in heat exchange communication with the fixed bed catalyst packed in the tubes.

11. A method for sorbent enhanced reformation of methane to form hydrogen, the method comprising:
introducing feed materials including methane and steam into a reforming unit containing a bed of methane reforming catalyst to produce a reformer product stream containing hydrogen and carbon dioxide;
introducing the reformer product stream into a sorbent unit containing a bed of carbon dioxide sorbent material to produce a sorbent unit product stream containing H₂ and used sorbent;
introducing the sorbent unit product stream a first separation unit to separate H₂ from the used sorbent;
introducing the used sorbent into a calciner unit to calcine at least a portion of the used sorbent to form a calciner product stream containing regenerated sorbent material and residual gases;
introducing the calciner product stream into a second separation unit to separate the regenerated sorbent material from the residual gases; and
introducing at least a portion of the regenerated sorbent material to the sorbent unit.

12. The method of claim 11 comprising a plurality of stages, each stage including at least one of said reforming units paired with at least one of said absorbent units.

13. The method of claim 11 wherein said separated H₂ is high purity H₂,

14. The method of claim 13 wherein said high purity H₂ is at either or both lower temperature and higher purity than product produced via steam-methane reformation.

15. The method of claim 11 wherein separation of sorbent and catalyst is maintained during the sorbent enhanced reformation.

16. The method of claim 11 wherein said absorbent unit is fluidized by one or more of feed and product gases.
